(19) United States
(12) Patent Application Publication
(10) Pub. No.: US 2026/0011289 A1
(43) Pub. Date: Jan. 8, 2026

(54) ELECTRONIC DEVICE

(71) Applicant: SAMSUNG DISPLAY CO., LTD., YONGIN-SI (KR)

(72) Inventors: HONGSOO KIM, Yongin-si (KR); SANGAN KWON, Yongin-si (KR); Namjeong KIM, Yongin-si (KR); JIYOUN KIM, Yongin-si (KR); JIHYE KIM, Yongin-si (KR); HANEUL KIM, Yongin-si (KR); CHANGNOH YOON, Yongin-si (KR); SUKHUN LEE, Yongin-si (KR)

(21) Appl. No.: 19/082,257

(22) Filed: Mar. 18, 2025

(30) Foreign Application Priority Data
Jul. 3, 2024 (KR) 10-2024-0087718

(51) Int. Cl. G09G 3/32

(52) U.S. Cl. CPC G09G 3/32; G09G 2310/08; G09G 2320/0276; G09G 2320/068; G09G 2330/021; G09G 2380/10

(57) ABSTRACT

An electronic device including: a display panel including a first pixel including a first pixel circuit, a first-type light emitting element electrically connected to the first pixel circuit, and a second-type light emitting element electrically connected to the first pixel circuit, wherein the first pixel is configured to operate in a first mode or a second mode different from the first mode; a first correction circuit configured to receive data and generate intermediate correction data by performing a primary correction on the data; a second correction circuit configured to generate first-type intermediate correction data by correcting first intermediate correction data corresponding to the first-type light emitting element among the intermediate correction data; and a third correction circuit configured to generate second-type intermediate correction data by correcting second intermediate correction data corresponding to the second-type light emitting element among the intermediate correction data.

### CROSS-REFERENCE TO RELATED APPLICATION

This application claims priority under 35 U.S.C. § 119 to Korean Patent Application No. 10-2024-0087718 filed on Jul. 3, 2024, in the Korean Intellectual Property Office, the disclosure of which is incorporated by reference herein in its entirety.

### TECHNICAL FIELD

Embodiments of the present disclosure described herein relate to an electronic device designed to reduce power consumption while enhancing display quality.

### DISCUSSION OF RELATED ART

Electronic devices, including display panels used in televisions, mobile phones, tablet PCs, and vehicles, continue to evolve. In certain environments where information protection or safety regulations are critical, viewing angles of electronic devices may be intentionally restricted. Additionally, different images can be displayed in separate areas of a single display panel to cater to varying needs.

### SUMMARY

Embodiments of the present disclosure provide a display device with reduced power consumption and improved display quality.

According to an embodiment of the present disclosure, there is provided an electronic device comprising: a display panel including a first pixel including a first pixel circuit, a first-type light emitting element electrically connected to the first pixel circuit, and a second-type light emitting element electrically connected to the first pixel circuit, wherein the first pixel is configured to operate in a first mode or a second mode different from the first mode; a first correction circuit configured to receive data and generate intermediate correction data by performing a primary correction on the data; a second correction circuit configured to generate first-type intermediate correction data by correcting first intermediate correction data corresponding to the first-type light emitting element among the intermediate correction data; and a third correction circuit configured to generate second-type intermediate correction data by correcting second intermediate correction data corresponding to the second-type light emitting element among the intermediate correction data.

When the first pixel operates in the first mode, the first-type light emitting element emits light, and the second-type light emitting element does not emit light, and when the first pixel operates in the second mode, the first-type light emitting element does not emit light, and the second-type light emitting element emits light.

When the first pixel operates in the first mode, the second correction circuit is turned on, and the third correction circuit is turned off, and when the first pixel operates in the second mode, the second correction circuit is turned off, and the third correction circuit is turned on.

A first area, in which the first pixel is placed, and a second area adjacent to the first area are defined in the display panel, and the display panel further includes a second pixel placed in the second area, the second pixel including a second pixel circuit, a third-type light emitting element electrically connected to the second pixel circuit, and a fourth-type light emitting element electrically connected to the second pixel circuit.

The second correction circuit is configured to generate third-type intermediate correction data by correcting third intermediate correction data corresponding to the third-type light emitting element among the intermediate correction data, and the third correction circuit is configured to generate fourth-type intermediate correction data by correcting fourth intermediate correction data corresponding to the fourth-type light emitting element among the intermediate correction data.

When the first pixel operates in the second mode and the second pixel operates in the first mode, the first-type light emitting element does not emit light, the second-type light emitting element emits light, the third-type light emitting element emits light, the fourth-type light emitting element does not emit light, the second correction circuit and the third correction circuit are turned on, the second correction circuit is configured to generate the third-type intermediate correction data, and the third correction circuit is configured to generate the second-type intermediate correction data.

When the first pixel and the second pixel operate in the first mode, the first-type light emitting element emits light, the second-type light emitting element does not emit light, the third-type light emitting element emits light, the fourth-type light emitting element does not emit light, the second correction circuit is turned on, the third correction circuit is turned off, and the second correction circuit is configured to generate the first-type intermediate correction data and the third-type intermediate correction data.

When the first pixel and the second pixel operate in the second mode, the first-type light emitting element does not emit light, the second-type light emitting element emits light, the third-type light emitting element does not emit light, the fourth-type light emitting element emits light, the second correction circuit is turned off, the third correction circuit is turned on, and the third correction circuit is configured to generate the second-type intermediate correction data and the fourth-type intermediate correction data.

The electronic device further comprises: a fourth correction circuit configured to receive at least one of the first-type intermediate correction data, the second-type intermediate correction data, the third-type intermediate correction data, and the fourth-type intermediate correction data, the fourth correction circuit is configured to generate first correction data by performing a secondary correction on at least one of the first-type intermediate correction data and the second-type intermediate correction data, and the fourth correction circuit is configured to generate second correction data by performing a secondary correction on at least one of the third-type intermediate correction data and the fourth-type intermediate correction data.

When the first pixel operates in the second mode and the second pixel operates in the first mode, the first correction data is provided to the second-type light emitting element, and the second correction data is provided to the third-type light emitting element.

When the first pixel and the second pixel operate in the first mode, the first correction data is provided to the first-type light emitting element, and the second correction data is provided to the third-type light emitting element.

When the first pixel and the second pixel operate in the second mode, the first correction data is provided to the second-type light emitting element, and the second correction data is provided to the fourth-type light emitting element.

The electronic device further comprises: a phase locked loop configured to output a first clock signal and a second clock signal, when the second correction circuit is turned on, the phase locked loop is configured to output the first clock signal to the second correction circuit, and when the third correction circuit is turned on, the phase locked loop is configured to output the second clock signal to the third correction circuit.

An active period of the first clock signal overlaps an inactive period of the second clock signal, and an active period of the second clock signal overlaps an inactive period of the first clock signal.

The electronic device further comprises: a fourth correction circuit configured to generate third-type intermediate correction data by correcting third intermediate correction data corresponding to the third-type light emitting element among the intermediate correction data; and a fifth correction circuit configured to generate fourth-type intermediate correction data by correcting fourth intermediate correction data corresponding to the fourth-type light emitting element among the intermediate correction data.

According to an embodiment of the present disclosure, there is provided an electronic device comprising: a display panel including a first pixel and a second pixel, wherein the first pixel includes a first pixel circuit, a first-type light emitting element electrically connected to the first pixel circuit, and a second-type light emitting element electrically connected to the first pixel circuit, and the second pixel includes a second pixel circuit, a third-type light emitting element electrically connected to the second pixel circuit, and a fourth-type light emitting element electrically connected to the second pixel circuit; a first correction circuit configured to receive data and generate intermediate correction data by performing a primary correction on the data; a second correction circuit configured to generate first-type intermediate correction data by correcting first intermediate correction data corresponding to the first-type light emitting element among the intermediate correction data, and generate third-type intermediate correction data by correcting third intermediate correction data corresponding to the third-type light emitting element among the intermediate correction data; and a third correction circuit configured to generate second-type intermediate correction data by correcting second intermediate correction data corresponding to the second-type light emitting element among the intermediate correction data, and generate fourth-type intermediate correction data by correcting fourth intermediate correction data corresponding to the fourth-type light emitting element among the intermediate correction data.

A first area and a second area adjacent to the first area are provided on the display panel, and the first pixel is placed in the first area, the second pixel is placed in the second area, and the first pixel and the second pixel are configured to be driven in a first mode or in a second mode different from the first mode.

When the first pixel is driven in the second mode and the second pixel is driven in the first mode, the first-type light emitting element does not emit light, the second-type light emitting element emits light, the third-type light emitting element emits light, the fourth-type light emitting element does not emit light, the second correction circuit and the third correction circuit are turned on, the second correction circuit is configured to generate the third-type intermediate correction data, and the third correction circuit is configured to generate the second-type intermediate correction data.

When the first pixel and the second pixel are driven in the first mode, the first-type light emitting element emits light, the second-type light emitting element does not emit light, the third-type light emitting element emits light, the fourth-type light emitting element does not emit light, the second correction circuit is turned on, the third correction circuit is turned off, and the second correction circuit is configured to generate the first-type intermediate correction data and the third-type intermediate correction data, and when the first pixel and the second pixel are driven in the second mode, the first-type light emitting element does not emit light, the second-type light emitting element emits light, the third-type light emitting element does not emit light, the fourth-type light emitting element emits light, the second correction circuit is turned off, the third correction circuit is turned on, and the third correction circuit is configured to generate the second-type intermediate correction data and the fourth-type intermediate correction data.

The electronic device further comprises: a first division correction circuit configured to receive a first portion of the intermediate correction data, the first division correction circuit including the second correction circuit and the third correction circuit; and a second division correction circuit configured to receive a second portion of the intermediate correction data, wherein the display panel includes a first division area and a second division area, wherein the first division correction circuit is configured to correct the first portion of the intermediate correction data that is provided to the first division area, and wherein the second division correction circuit is configured to correct the second portion of the intermediate correction data that is provided to the second division area.

### BRIEF DESCRIPTION OF THE DRAWINGS

The objectives and features of the present disclosure will be clarified through a detailed description of the embodiments, provided in conjunction with the accompanying drawings.

FIG. 1A is a drawing illustrating an interior of a vehicle, in which an electronic device is placed, according to an embodiment of the present disclosure.

FIG. 1B is a drawing illustrating an interior of a vehicle, in which an electronic device is placed, according to an embodiment of the present disclosure.

FIG. 2 is a drawing illustrating a plan view of an electronic device inside a vehicle, according to an embodiment of the present disclosure.

FIG. 3 is a block diagram of an electronic device, according to an embodiment of the present disclosure.

FIG. 4 is a circuit diagram of a pixel, according to an embodiment of the present disclosure.

FIG. 5 is an enlarged plan view illustrating some pixel units, according to an embodiment of the present disclosure.

FIG. 6 is a block diagram showing a configuration for data correction of a driving controller, according to an embodiment of the present disclosure.

FIG. 7 is a timing diagram showing signals, according to an embodiment of the present disclosure.

FIG. 8 is a timing diagram showing signals, according to an embodiment of the present disclosure.

FIG. 9 is a timing diagram showing signals, according to an embodiment of the present disclosure.

FIG. 10 is a timing diagram showing signals, according to an embodiment of the present disclosure.

FIG. 11 is a drawing illustrating a plan view of a display panel, according to an embodiment of the present disclosure.

FIG. 12 is a block diagram showing a configuration for data correction of a driving controller, according to an embodiment of the present disclosure.

### DETAILED DESCRIPTION OF THE EMBODIMENTS

In the specification, is the terms “on”, “connected with”, or “coupled with” when used to describe a relationship between a first component (or region, layer, part, portion, etc.) a second component, indicate that the first component may be directly on, connected with, or coupled with the second component, or that a third component is interposed between them.

The same reference numerals are used to denote identical components. In drawings, the thickness, ratios, and dimensions of components may be exaggerated to facilitate the explanation of technical details. The term “and/or” includes one or more combinations of the associated elements as defined.

Although the terms “first”, “second”, etc. may be used to describe various components, the components should not be construed as being limited by the terms. These terms are used to distinguish one component from another component. For example, a first component may be referred to as a second component, and similarly, the second component may be referred to as the first component. The articles “a,” “an,” and “the” are singular in that they have a single referent, but the use of the singular form in the specification should not preclude the presence of more than one referent.

Additionally, the terms “under”, “below”, “on”, “above”, and similar expressions are used to describe the spatial relationship of components illustrated in drawings. These relative terms are described based on the orientation shown in the drawings.

It will be understood that the terms “include”, “comprise”, “have”, etc. specify the presence of features, numbers, steps, operations, elements, or components, described in the specification, or a combination thereof. It is to be further understood that these terms do not preclude the presence or additional possibility of one or more other features, numbers, steps, operations, elements, or components or a combination thereof.

The terms “part” and “unit” refer to either a software or hardware component that performs a specific function. Hardware components may include, for example, a field-programmable gate array (FPGA) or an application-specific integrated circuit (ASIC). Software components may consist of executable codes and/or associated data stored in an addressable medium. Examples of the software components include object-oriented software components, class components, and task components, processes, functions, attributes, procedures, subroutines, program code segments, drivers, firmware, microcodes, circuits, data, databases, data structures, tables, arrays, and variables.

Unless otherwise defined, all terms (including technical terms and scientific terms) used in the specification have the same meaning as commonly understood by one skilled in the art to which the present disclosure belongs. Furthermore, terms commonly found in standard dictionaries should be interpreted in a manner consistent with their meaning in the context of the relevant technology, rather than being given overly formal or idealized definitions, unless explicitly defined otherwise in this specification.

Hereinafter, embodiments of the present disclosure will be described with reference to the accompanying drawings.

The present disclosure relates to an electronic device with a display panel designed to reduce power consumption and improve display quality. It features a dual-mode operation where a single pixel circuit controls two types of light-emitting elements, operating in either a public mode with full viewing angles or a private mode with restricted viewing angles for privacy. Dynamic correction circuits adjust luminance and color balance based on the mode and element type, ensuring consistent display quality while optimizing power efficiency by activating only necessary circuits.

The display panel is ideal for environments like vehicles, where different screen areas can provide tailored information to the driver and passenger. By dividing the display into independently operable areas and using precise data correction, the present disclosure enhances viewing experiences and conserves energy. Phase-locked loops further manage signal timing, ensuring efficient and mode-specific functionality.

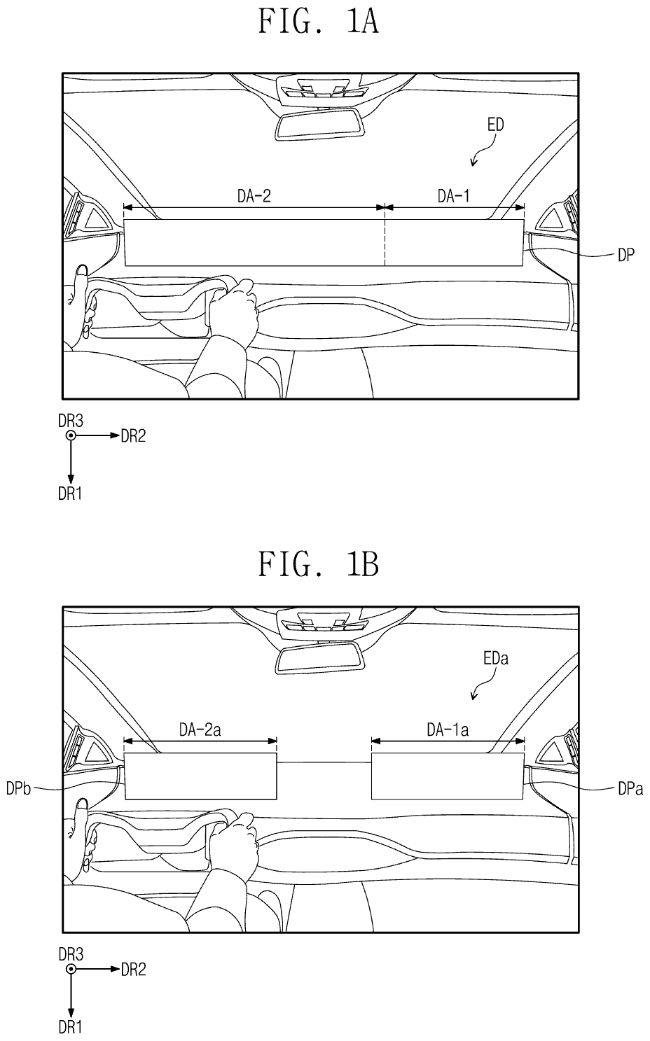

FIG. 1A is a drawing illustrating an interior of a vehicle, in which an electronic device ED is placed, according to an embodiment of the present disclosure. FIG. 1B is a drawing illustrating an interior of a vehicle, in which an electronic device EDa is placed, according to an embodiment of the present disclosure.

Referring to FIG. 1A, the electronic device ED may be installed within a vehicle to deliver various types of information to the driver and the front seat passenger. The electronic device ED may include a display panel DP.

The display panel DP may be a component that actually generates images. In other words, the display panel DP is a component responsible for generating visual images. The display panel DP may be a light emitting display panel. For example, the display panel DP may be an organic light emitting display panel, an inorganic light emitting display panel, an organic-inorganic light emitting display panel, a quantum dot display panel, a micro-LED display panel, or a nano-LED display panel.

The display panel DP may include a first area DA-1 and a second area DA-2 which are seamlessly integrated into a single display panel DP. The first area DA-1 may be positioned closer to the front seat passenger, and the second area DA-2 may be positioned closer to the driver.

Separate images including information relevant to the driver and the front seat passenger may be displayed in the first area DA-1 and the second area DA-2. For example, images oriented in a third direction DR3, which intersects a first direction DR1 and a second direction DR2, may be displayed on the first area DA-1 and the second area DA-2 via a display surface parallel to the first direction DR1 and the second direction DR2. While the display surface is described as being flat, it may alternatively be a curved surface.

In an embodiment of the present disclosure, the first area DA-1 may display images intended for the front seat passenger. These images may include both information unrelated to driving and, optionally, additional information for passenger convenience. The second area DA-2 may display images essential for driving to the driver. For example, driving-related information such as speed, vehicle status, internal control settings, and navigation details may be displayed in the second area DA-2 to assist the driver while operating the vehicle.

In a non-driving environment, both the driver and the front seat passenger may view the images displayed in the first area DA-1 and the second area DA-2. However, in a driving environment, the front seat passenger may view images from both the first area DA-1 and the second area DA-2, as in the non-driving environment. In contrast, the driver may be in a controlled viewing environment, where their viewing angle restricts them from seeing the images displayed in the first area DA-1.

Referring to FIG. 1B, the electronic device EDa may include a first display panel DPa and a second display panel DPb. FIG. 1B illustrates the first display panel DPa and the second display panel DPb are completely separated and spaced apart from each other, but the present disclosure is not particularly limited thereto. For example, the first display panel DPa and the second display panel DPb may be provided adjacent to each other, creating the appearance of a single, unified display panel when viewed externally.

The first display panel DPa may include a first area DA-1a. The second display panel DPb may include a second area DA-2a. The first area DA-1a of the first display panel DPa may be selectively driven to display images, which are visually perceived at only the passenger seat, or images visually perceived at both the passenger seat and the driver seat. The second area DA-2a of the second display panel DPb may be driven to display images visually perceived at both the passenger seat and the driver seat. However, depending on a selected option, the second area DA-2a of the second display panel DPb may display images that are visually perceptible only from the driver seat.

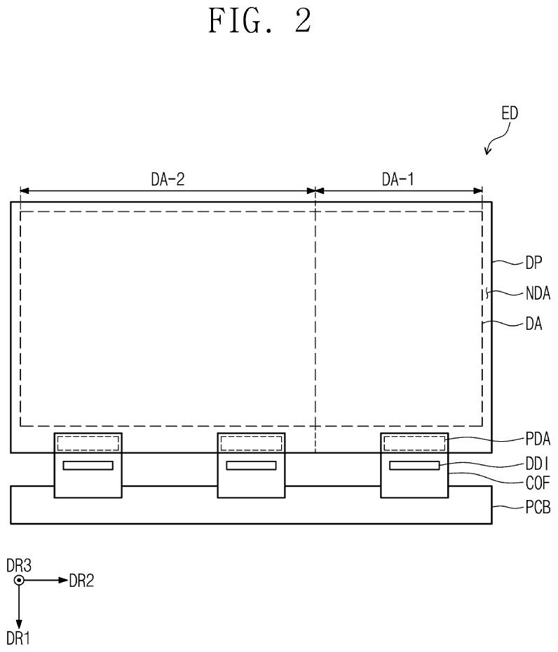

FIGS. 1A and 1B illustrate only the first area DA-1 or DA-1a and the second area DA-2 or DA-2a. However, the display area DA (see FIG. 2) may further include a third area in which an image provided to both the driver and the front seat passenger is displayed. For example, such commonly displayed images may include information like the current exterior temperature, interior vehicle temperature, sound volume, or similar details. Accordingly, the driver and the front seat passenger may watch images displayed in the third area not only in a non-driving environment but also in a driving environment. However, an embodiment is not limited thereto. Four or more areas may be included.

FIG. 2 is a drawing illustrating a plan view of the electronic device ED inside a vehicle, according to an embodiment of the present disclosure.

Referring to FIG. 1A and FIG. 2, the electronic device ED may include the display panel DP, a connection film COF, and a circuit board PCB.

A display area DA and a non-display area NDA may be provided in the display panel DP. The display area DA may include the first area DA-1 and the second area DA-2 depending on the field of view of each of a driver and a front seat passenger. The first area DA-1 and the second area DA-2 may be referred to as “separate display areas”. This separation implies that the operating modes of the first area DA-1 and the second area DA-2 are different from each other and thus the first area DA-1 and the second area DA-2 are operationally independent. Moreover, the fact that areas are separated may imply that the first area DA-1a and the second area DA-2a are completely separated from each other, as illustrated in FIG. 1B.

In an embodiment of the present disclosure, the plurality of connection films COF may be provided. A driving circuit DDI (e.g., a data driving circuit DDI) for driving the display panel DP may be mounted on each of the connection films COF. The plurality of connection films COF may be coupled to the non-display area NDA of the display panel DP. For example, the connection films COF may be attached to one side of the display panel DP.

In an embodiment of the present disclosure, the connection films COF may be coupled to a pad area PDA of the display panel DP. The pad area PDA may be provided in the non-display area NDA of the display panel DP. The connection films COF and the display panel DP may be coupled to each other by an anisotropic conductive film (ACF), but are not particularly limited thereto.

The circuit board PCB may be electrically connected to the display panel DP through the connection films COF. The electronic device ED may include a chip (e.g., a timing controller) that controls the operation of the display panel DP. The timing controller may be located outside the circuit board PCB to deliver signals for driving the display panel DP to the data driving circuit DDI. However, an embodiment is not limited thereto. The timing controller may be mounted on the circuit board PCB.

FIG. 2 illustrates three connection films COF and one circuit board PCB. However, the present disclosure is not limited thereto. For example, the plurality of circuit boards PCB may be used in combination with the connection films COF. Additionally, the number of connection films COF and circuit boards PCB may vary depending on factors such as the resolution and size of the display panel DP and the specifications of the data driving circuit DDI.

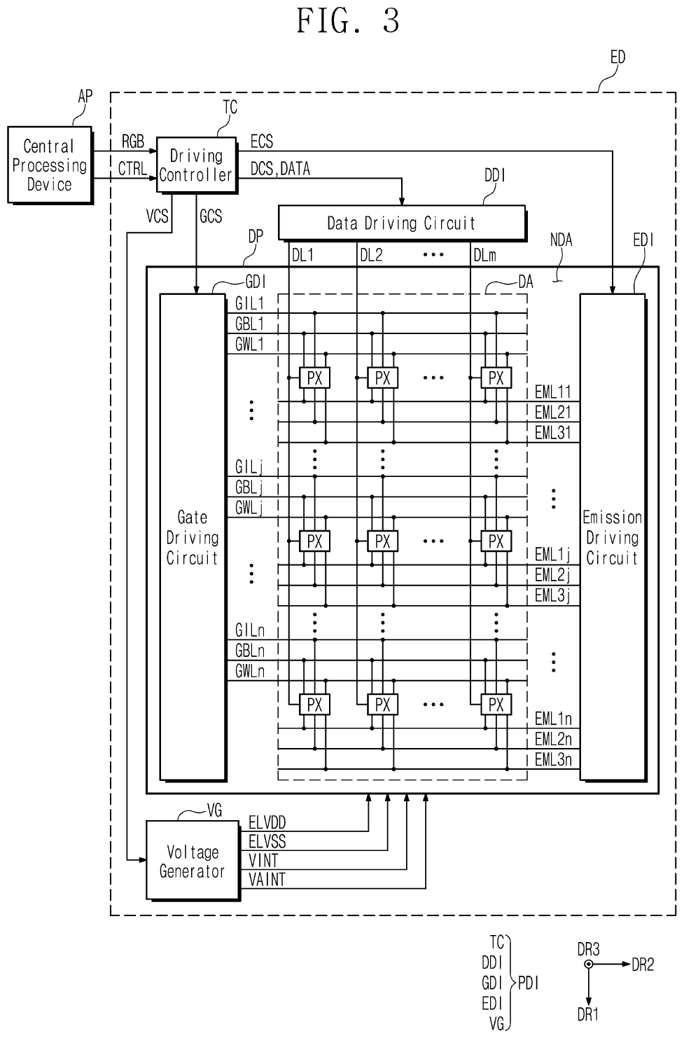

FIG. 3 is a block diagram of the electronic device ED, according to an embodiment of the present disclosure.

Referring to FIG. 3, the electronic device ED may receive a signal from a central processing device AP, such as an external host. The electronic device ED may include the display panel DP and a panel driving circuit PDI for driving the display panel DP. The panel driving circuit PDI may include a driving controller TC, the data driving circuit DDI, a gate driving circuit GDI, an emission driving circuit EDI, and a voltage generator VG.

The central processing device AP may generate an image signal RGB of an image to be displayed through the electronic device ED and may deliver the image signal RGB to the driving controller TC. Moreover, the central processing device AP may deliver a control signal CTRL including synchronization information for controlling the image display timing of the electronic device ED to the driving controller TC.

The driving controller TC may receive the image signal RGB and the control signal CTRL from the central processing device AP. The driving controller TC may generate an image data signal DATA obtained by converting the data format of the image signal RGB to ensure compatibility with the data driving circuit DDI its interface specifications. The driving controller TC may output a first control signal DCS, a second control signal GCS, a third control signal ECS, and a fourth control signal VCS.

The data driving circuit DDI may receive the first control signal DCS and the image data signal DATA from the driving controller TC. The data driving circuit DDI may convert the image data signal DATA into data signals and may output the data signals to data lines DL1 to DLm. The data signals may be analog voltages corresponding to grayscale values of the image data signal DATA. The data lines DL1 to DLm may be arranged in the second direction DR2, and each of the data lines DL1 to DLm may extend in the first direction DR1.

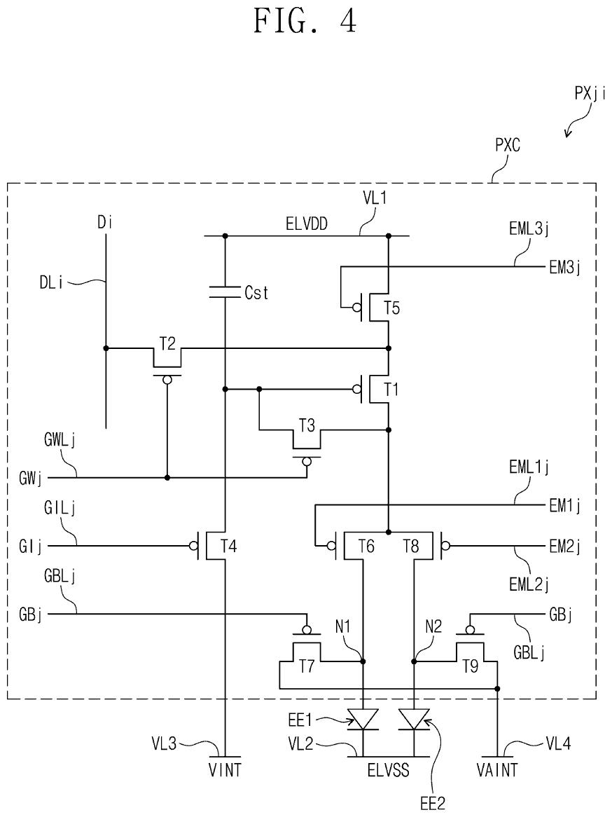

The gate driving circuit GDI and the emission driving circuit EDI may be placed in the non-display area NDA of the display panel DP, but are not specifically limited thereto. For example, at least part of the gate driving circuit GDI and the emission driving circuit EDI may be placed in the display area DA. The gate driving circuit GDI and the emission driving circuit EDI may include transistors formed through the same process as a pixel circuit PXC (see FIG. 4).

The gate driving circuit GDI may be electrically connected to initialization gate lines GIL1 to GILn, write gate lines GWL1 to GWLn, and black gate lines GBL1 to GBLn. Accordingly, the gate driving circuit GDI may receive the second control signal GCS and may output gate signals to the initialization gate lines GIL1 to GILn, the write gate lines GWL1 to GWLn, and the black gate lines GBL1 to GBLn.

The emission driving circuit EDI may be electrically connected to first emission control lines EML11 to EML1n, second emission control lines EML21 to EML2n, and third emission control lines EML31 to EML3n. Accordingly, the emission driving circuit EDI may receive the third control signal ECS and may output emission control signals to the first emission control lines EML11 to EML1n, the second emission control lines EML21 to EML2n, and the third emission control lines EML31 to EML3n.

The gate driving circuit GDI and the emission driving circuit EDI may be spaced apart from each other with the display area DA therebetween. However, this is just an example, and the gate driving circuit GDI and the emission driving circuit EDI may be placed on the same side of the display area DA. Alternatively, at least part of the gate driving circuit GDI and the emission driving circuit EDI may overlap the display area DA.

The initialization gate lines GIL1 to GILn, the write gate lines GWL1 to GWLn, the black gate lines GBL1 to GBLn, the first emission control lines EML11 to EML1n, the second emission control lines EML21 to EML2n, and the third emission control lines EML31 to EML3n may extend in the second direction DR2.

The display panel DP may include a plurality of pixels PX placed in the display area DA. The pixels PX may be repeatedly arranged in the first direction DR1 and the second direction DR2 intersecting the first direction DR1.

Each of the pixels PX may include one or more light emitting elements EE1 and EE2 (see FIG. 4) and a pixel circuit PXC (see FIG. 4) that controls the light emission of the light emitting elements EE1 and EE2. The pixel circuit PXC may include one or more transistors and one or more capacitors.

Each of the pixels PX may be electrically connected to three gate lines, three emission control lines, and one data line. For example, as illustrated in FIGS. 3 and 4, a first row of pixels may be connected to the gate lines GIL1, GWL1, and GBL1 and the emission control lines EML11, EML21, and EML31. A first column of pixels may be connected to the data line DL1. Additionally, a j-th row of pixels may be connected to the gate lines GILj, GWLj, and GBLj and the emission control lines EML1j, EML2j, and EML3j.

The voltage generator VG may generate voltages necessary for the operation of the display panel DP. In an embodiment, the voltage generator VG may generate a first driving voltage ELVDD, a second driving voltage ELVSS, a first initialization voltage VINT, and a second initialization voltage VAINT.

FIG. 4 is a circuit diagram of a pixel PXji, according to an embodiment of the present disclosure.

Referring to FIGS. 3 and 4, a pixel PXji may be connected to the j-th initialization gate line GILj, the j-th black gate line GBLj, the j-th write gate line GWLj, the j-th first emission control line EML1j, the j-th second emission control line EML2j, the j-th third emission control line EML3j, and the i-th data line DLi. Each of the pixels PX shown in FIG. 3 may have the same circuit configuration as the pixel PXji shown in FIG. 4.

The pixel PXji according to an embodiment of the present disclosure may include the pixel circuit PXC, the first-type light emitting element EE1, and the second-type light emitting element EE2. The pixel circuit PXC may include first to ninth transistors T1, T2, T3, T4, T5, T6, T7, T8, and T9 and a capacitor Cst.

Each of the first to ninth transistors T1, T2, T3, T4, T5, T6, T7, T8, and T9 may be a P-type thin film transistor having a silicon semiconductor layer, for example, a low-temperature polycrystalline silicon (LTPS) semiconductor layer. However, the present disclosure is not limited thereto. Some of the first to ninth transistors T1, T2, T3, T4, T5, T6, T7, T8, and T9 are N-type thin film transistors with an oxide semiconductor as a semiconductor layer, and the remainder may be P-type thin film transistors. In an embodiment, all of the first to ninth transistors T1, T2, T3, T4, T5, T6, T7, T8, and T9 may be N-type thin film transistors.

The j-th initialization gate line GILj may deliver an initialization gate signal GIj; the j-th black gate line GBLj may deliver a black gate signal GBj; the j-th write gate line GWLj may deliver a write gate signal GWj; the j-th first emission control line EML1j may deliver a first emission control signal EM1j; the j-th second emission control line EML2j may deliver a second emission control signal EM2j; the j-th third emission control line EML3j may deliver a third emission control signal EM3j; and the i-th data line DLi may deliver a data signal Di. The data signal Di may have a voltage level corresponding to a grayscale value of the image data signal DATA output from the driving controller TC.

Moreover, the pixel PXji may be connected to first to fourth driving voltage lines VL1, VL2, VL3, and VL4. The first driving voltage line VL1 may deliver the first driving voltage ELVDD. The second driving voltage line VL2 may deliver the second driving voltage ELVSS. The third driving voltage line VL3 may deliver the first initialization voltage VINT and may be referred to as a “first initialization voltage line”. The fourth driving voltage line VL4 may deliver the second initialization voltage VAINT and may be referred to as a “second initialization voltage line”.

The first transistor T1 includes a first electrode electrically connected to the first driving voltage line VL1 via the fifth transistor T5, a second electrode electrically connected to the anode of the first-type light emitting element EE1 via the sixth transistor T6, or electrically connected to the anode of the second-type light emitting element EE2 via the eighth transistor T8, and a gate electrode. The first transistor T1 may be referred to as a “driving transistor”.

The second transistor T2 may be connected between the first electrode of the first transistor T1 and the data line DLi. The second transistor T2 includes a first electrode connected to the data line DLi, a second electrode connected to the first electrode of the first transistor T1, and a gate electrode connected to the j-th write gate line GWLj. The second transistor T2 may be turned on in response to the write gate signal GWj received through the j-th write gate line GWLj to deliver the data signal Di delivered from the data line DLi to the first transistor T1. The second transistor T2 may be referred to as a “switching transistor”.

The capacitor Cst may be connected between the gate electrode of the first transistor T1 and the first driving voltage line VL1.

The third transistor T3 includes a first electrode connected to the second electrode of the first transistor T1, a second electrode connected to the gate electrode of the first transistor T1, and a gate electrode connected to the j-th write gate line GWLj. The third transistor T3 may be turned on in response to the write gate signal GWj to connect the gate electrode of the first transistor T1 to the second electrode of the first transistor T1.

The fourth transistor T4 includes a first electrode connected to the gate electrode of the first transistor T1, a second electrode connected to the third driving voltage line VL3, and a gate electrode connected to the j-th initialization gate line GILj. The fourth transistor T4 may be turned on in response to the initialization gate signal GIj received through the j-th initialization gate line GILj to deliver the first initialization voltage VINT to the gate electrode of the first transistor T1 such that the voltage of the gate electrode of the first transistor T1 is initialized.

The fifth transistor T5 may be connected between the first electrode of the first transistor T1 and the first driving voltage line VL1. The fifth transistor T5 includes a first electrode connected to the first driving voltage line VL1, a second electrode connected to the first electrode of the first transistor T1, and a gate electrode connected to the j-th third emission control line EML3j. The fifth transistor T5 may be turned on in response to the third emission control signal EM3j received through the j-th third emission control line EML3j. The fifth transistor T5 may be referred to as a “third emission control transistor”.

The sixth transistor T6 may be connected between the second electrode of the first transistor T1 and the first-type light emitting element EE1. The sixth transistor T6 includes a first electrode connected to the second electrode of the first transistor T1, a second electrode connected to the anode of the first-type light emitting element EE1, and a gate electrode connected to the j-th first emission control line EML1j. The sixth transistor T6 may be turned on in response to the first emission control signal EM1j received through the j-th first emission control line EML1j. The sixth transistor T6 may be referred to as a “first emission control transistor”.

The seventh transistor T7 may be connected between the fourth driving voltage line VLA and a first node N1 between the sixth transistor T6 and the first-type light emitting element EE1. The seventh transistor T7 includes a first electrode connected to the anode of the first-type light emitting element EE1, a second electrode connected to the fourth driving voltage line VL4, and a gate electrode connected to the j-th black gate line GBLj. The seventh transistor T7 may be turned on in response to the black gate signal GBj received through the j-th black gate line GBLj to connect the first-type light emitting element EE1 to the fourth driving voltage line VLA providing the second initialization voltage VAINT. The black gate signal GBj may be referred to as the initialization gate signal GBj. The seventh transistor T7 may be referred to as a first initialization transistor.

The eighth transistor T8 may be connected between the second electrode of the first transistor T1 and the second-type light emitting element EE2. The eighth transistor T8 includes a first electrode connected to the second electrode of the first transistor T1, a second electrode connected to the anode of the second-type light emitting element EE2, and a gate electrode connected to the j-th second emission control line EML2j. The eighth transistor T8 may be turned on in response to the second emission control signal EM2j received through the j-th second emission control line EML2j. The eighth transistor T8 may be referred to as a “second emission control transistor”.

The ninth transistor T9 may be connected between the fourth driving voltage line VLA and a second node N2 between the eighth transistor T8 and the second-type light emitting element EE2. The ninth transistor T9 includes a first electrode connected to the anode of the second-type light emitting element EE2, a second electrode connected to the fourth driving voltage line VL4, and a gate electrode connected to the j-th black gate line GBLj. The ninth transistor T9 may be turned on in response to the black gate signal GBj received through the j-th black gate line GBLj to connect the second-type light emitting element EE2 to the fourth driving voltage line VL4 providing the second initialization voltage VAINT. The black gate signal GBj may be referred to as the “initialization gate signal GBj”. The ninth transistor T9 may be referred to as a “second initialization transistor”.

In an embodiment of the present disclosure, as the fifth transistor T5 and the sixth transistor T6 are turned on, a current path may be formed between the first driving voltage line VL1 and the first-type light emitting element EE1 through the fifth transistor T5, the first transistor T1, and the sixth transistor T6. Alternatively, as the fifth transistor T5 and the eighth transistor T8 are turned on, a current path may be formed between the first driving voltage line VL1 and the second-type light emitting element EE2 through the fifth transistor T5, the first transistor T1, and the eighth transistor T8.

The first-type light emitting element EE1 and the second-type light emitting element EE2, which are connected to the one pixel circuit PXC and controlled together, may emit light of substantially the same color. The cathode of the first-type light emitting element EE1 and the cathode of the second-type light emitting element EE2 may be electrically connected to the second driving voltage line VL2, which is supplied with the second driving voltage ELVSS different from the first driving voltage ELVDD.

Depending on whether the environment is a driving or non-driving environment, the first-type light emitting element EE1 and the second-type light emitting element EE2 may selectively emit light. For example, in a driving environment, the first-type light emitting element EE1 may not emit light (e.g., it may remain inactive), and the second-type light emitting element EE2 may emit light.

Unlike the first-type light emitting element EE1, a plurality of light control layers may be positioned above the second-type light emitting element EE2. Accordingly, in a driving environment where the second-type light emitting element EE2 emits light, the emitted light may be subjected to a viewing angle control environment, with its path restricted by the light control layers placed over the second-type light emitting element EE2.

In an embodiment of the present disclosure, each of the first-type light emitting element EE1 and the second-type light emitting element EE2 may be selectively driven in a first mode or a second mode. In this case, the first mode may be a public mode, and the second mode may be a private mode.

The private mode may correspond to a viewing angle control environment mode. In a non-driving environment, the first-type light emitting element EE1 may emit light and may operate in the first mode, referred to as the public mode. In this case, the second-type light emitting element EE2 may not emit light (e.g., remain inactive). However, this is not limiting, as both the first-type light emitting element EE1 and the second-type light emitting element EE2 may emit light simultaneously. In a driving environment, the first-type light emitting element EE1 and the second-type light emitting element EE2 may operate in a second mode, referred to as a private mode, where the first-type light emitting element EE1 does not emit light, and the second-type light emitting element EE2 emits light.

Referring to FIG. 4, in a non-driving environment, the first-type light emitting element EE1 may emit light as the sixth transistor T6 is turned on in response to the j-th first emission control line EML1j. In the driving environment, the second-type light emitting element EE2 may emit light as the eighth transistor T8 is turned on in response to the j-th second emission control line EML2j.

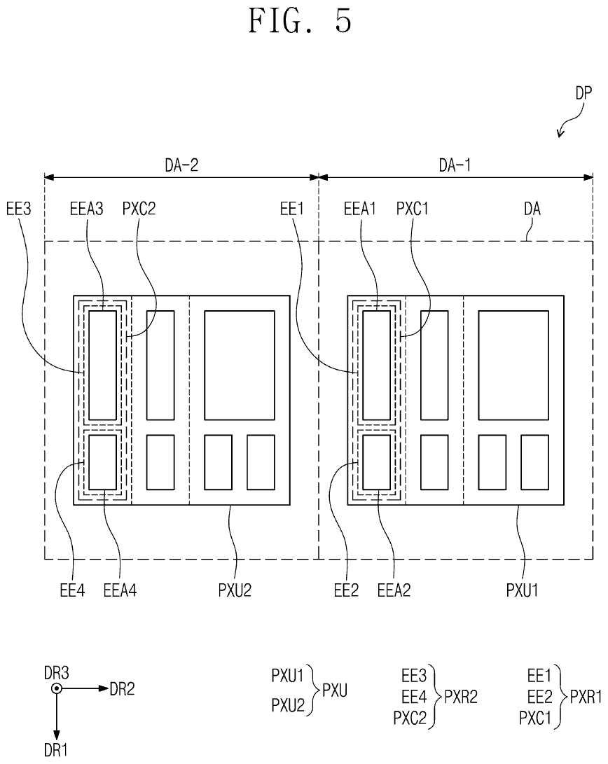

FIG. 5 is an enlarged plan view illustrating some pixel units PXU, according to an embodiment of the present disclosure.

Referring to FIGS. 3 and 5, the display panel DP may include a plurality of pixel units PXU. The pixel units PXU may be repeatedly arranged in the first direction DR1 and the second direction DR2 intersecting the first direction DR1. FIG. 5 illustrates two pixel units PXU1 and PXU2.

Each of the plurality of pixel units PXU may include a plurality of pixels PX. For example, the pixels PX may include a red pixel, a green pixel, and a blue pixel. The pixel units PXU may include the first pixel unit PXU1 and the second pixel unit PXU2. In FIG. 5, it is described that the one pixel unit PXU1 or PXU2 includes three pixels. However, the one pixel unit PXU1 or PXU2 may include four or more pixels or may include two pixels.

As shown in FIG. 5, the first pixel unit PXU1 may be placed in the first area DA-1, and the second pixel unit PXU2 may be placed in the second area DA-2. The first pixel unit PXU1 may include a first pixel PXR1. The second pixel unit PXU2 may include a second pixel PXR2. The first pixel PXR1 and the second pixel PXR2 may be configured to emit light of the same color. For example, each of the first pixel PXR1 and the second pixel PXR2 may be a red pixel. The first pixel unit PXU1 may further include a green pixel and a blue pixel, and the second pixel unit PXU2 may further include a green pixel and a blue pixel. Hereinafter, the description will focus on the first pixel PXR1 and the second pixel PXR2, while the descriptions of the green pixel and blue pixel are omitted as they are substantially identical in functionality.

The first pixel PXR1 arranged in the first area DA-1 may include a first pixel circuit PXC1, the first-type light emitting element EE1 electrically connected to the first pixel circuit PXC1, and the second-type light emitting element EE2 electrically connected to the first pixel circuit PXC1.

The second pixel PXR2 arranged in the second area DA-2 may include a second pixel circuit PXC2, a third-type light emitting element EE3 electrically connected to the second pixel circuit PXC2, and a fourth-type light emitting element EE4 electrically connected to the second pixel circuit PXC2.

In an embodiment of the present disclosure, the size of an emission area EEA1 of the first-type light emitting element EE1 in the first pixel PXR1 may be larger than the size of an emission area EEA2 of the second-type light emitting element EE2. The size of an emission area EEA3 of the third-type light emitting element EE3 in the second pixel PXR2 may be larger than the size of an emission area EEA4 of the fourth-type light emitting element EE4. However, this is not limiting, as the sizes of each of the emission areas EEA1, EEA2, EEA3, and EEA4 of the light emitting elements EE1, EE2, EE3, and EE4 may be the same as each other.

In an embodiment of the present disclosure, the color of light emitted by the first-type light emitting element EE1 may be substantially the same as that emitted by the second-type light emitting element EE2. The color of light emitted by the third-type light emitting element EE3 may be substantially the same as that emitted by the fourth-type light emitting element EE4. For example, all of the four light emitting elements EE1, EE2, EE3, and EE4 illustrated in FIG. 5 may emit red light. Accordingly, both the first pixel PXR1 and the second pixel PXR2 may be red pixels.

In FIG. 5, a red pixel is described as an example. Detailed descriptions of the green pixel and the blue pixel included in each of the pixel units PXU are omitted for simplicity. FIG. 5 also illustrates that the emission areas of certain light emitting elements within blue pixels are divided into two separate regions. However, this is not a limitation. For example, the emission areas of some light emitting elements within blue pixels may instead be merged into single, continuous area.

Each of the first area DA-1 and the second area DA-2 of the display panel DP may be selectively driven in a first mode or in a second mode different from the first mode. In the first mode, the first-type light emitting element EE1 and the third-type light emitting element EE3 may emit light, and the second-type light emitting element EE2 and the fourth-type light emitting element EE4 may not emit light. However, an embodiment is not limited thereto. In the first mode, all of the four light emitting elements EE1, EE2, EE3, and EE4 may emit light. In the second mode, the first-type light emitting element EE1 and the third-type light emitting element EE3 may not emit light, and the second-type light emitting element EE2 and the fourth-type light emitting element EE4 may emit light.

The first mode may be referred to as a public mode, and the second mode may be referred to as a private mode. The private mode may correspond to a viewing angle control environment mode. For example, when the first area DA-1, located on the side of a front seat passenger, operates in the private mode (the second mode), a driver may be in a viewing angle control environment where they are unable to see the image displayed in the first area DA-1.

In an embodiment of the present disclosure, the first-type light emitting element EE1 of the first pixel PXR1 and the third-type light emitting element EE3 of the second pixel PXR2 may be light emitting elements of substantially the same type. The second-type light emitting element EE2 of the first pixel PXR1 and the fourth-type light emitting element EE4 of the second pixel PXR2 may be light emitting elements of substantially the same type.

In an embodiment of the present disclosure, a correction value applied to data in the first mode may differ from a correction value applied to data in the second mode. For example, the correction value may be used to correct luminance and may include a gamma value. In other words, the correction value may be used to adjust luminance. Specifically, for the same grayscale, the gamma value applied in the first mode may be smaller than the gamma value applied in the second mode. Consequently, by applying different correction values in the first and second modes when displaying data of the same grayscale, consistent luminance can be achieved. This is true even if there are differences in the emission area sizes, such as between the first-type light emitting element EE1 and the second-type light emitting element EE2, or between the third-type light emitting element EE3 and the fourth-type light emitting element EE4.

In an embodiment of the present disclosure, referring to FIG. 3, the driving controller TC may perform data correction to resolve the degradation of display quality due to brightness difference. In other words, the driving controller TC may perform data correction to address display quality degradation caused by brightness differences. When the data correction is performed, the driving controller TC may output the corrected data to the data driving circuit DDI. This will be more fully detailed later.

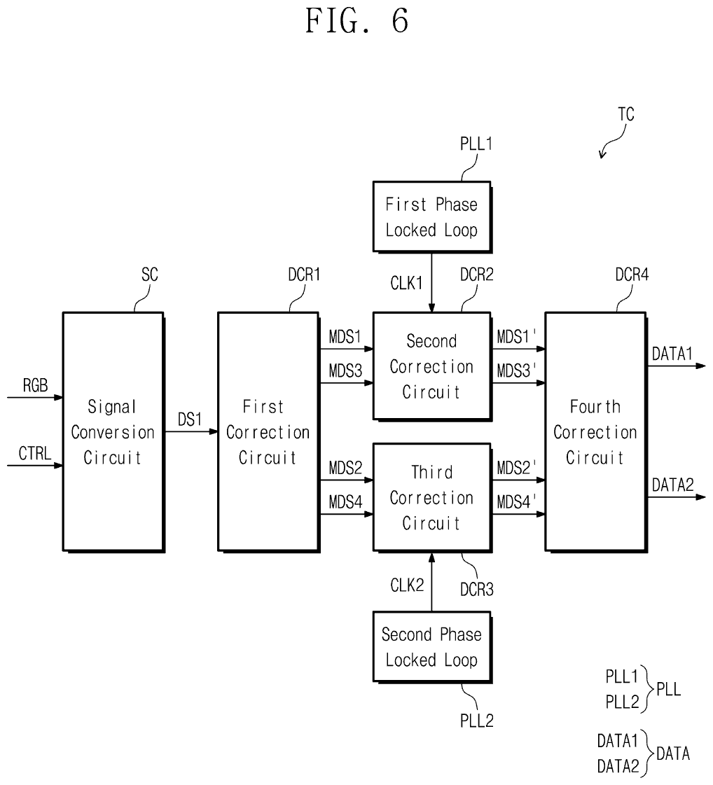

FIG. 6 is a block diagram showing a configuration for data correction of the driving controller TC, according to an embodiment of the present disclosure.

Referring to FIGS. 2, 5, and 6, the driving controller TC may include a signal conversion circuit SC and correction units DCR1, DCR2, DCR3, and DCR4. The correction units DCR1, DCR2, DCR3, and DCR4 may include a first correction circuit DCR1, a second correction circuit DCR2, a third correction circuit DCR3, and a fourth correction circuit DCR4. In an embodiment of the present disclosure, at least some blocks shown in FIG. 6 may be omitted.

The signal conversion circuit SC may receive the image signal RGB and the control signal CTRL from the central processing device AP (see FIG. 3). The signal conversion circuit SC may convert the received image signal RGB and the received control signal CTRL into data DS1 that conform to the required specifications, and subsequently deliver the converted data to the first correction circuit DCR1. For example, the signal conversion circuit SC may include a DSC decoder. The signal conversion circuit SC may output the data DS1 obtained by decoding the received image signal RGB.

In an embodiment of the present disclosure, the correction units DCR1, DCR2, DCR3, and DCR4 may be configured to correct the data DS1 received from the signal conversion circuit SC and to provide the corrected data to the first pixel PXR1 disposed in the first area DA-1 of the display panel DP and the second pixel PXR2 disposed in the second area DA-2. The correction units DCR1, DCR2, DCR3, and DCR4 may be configured to perform data correction tailored to each mode, corresponding to the first area DA-1 and the second area DA-2 in either the first mode or the second mode.

In an embodiment of the present disclosure, the first correction circuit DCR1 may receive the data DS1 from the signal conversion circuit SC. The first correction circuit DCR1 may be configured to perform a primary correction on the received data DS1 and generate intermediate correction data MDS1, MDS2, MDS3, and MDS4. This correction is carried out irrespective of whether the first area DA-1 and the second area DA-2 operate in the first mode or the second mode. For example, regardless of the mode, the first correction circuit DCR1 may perform image quality correction corresponding to the grayscale value of each of the first pixel PXR1 in the first area DA-1 and the second pixel PXR2 in the second area DA-2.

The intermediate correction data MDS1, MDS2, MDS3, and MDS4 generated from the first correction circuit DCR1 may include the first intermediate correction data MDS1, the second intermediate correction data MDS2, the third intermediate correction data MDS3, and the fourth intermediate correction data MDS4. The first intermediate correction data MDS1 and the second intermediate correction data MDS2 may be data provided to the same pixel and may be substantially the same data. In other words, the first intermediate correction data MDS1 and the second intermediate correction data MDS2 correspond to the same pixel. Moreover, the third intermediate correction data MDS3 and the fourth intermediate correction data MDS4 may be data provided to the same pixel and may be substantially the same data. In other words, the third intermediate correction data MDS3 and the fourth intermediate correction data MDS4 correspond to the same pixel.

The first intermediate correction data MDS1 and the second intermediate correction data MDS2 may correspond to the first pixel PXR1 in the first area DA-1. For example, the first intermediate correction data MDS1 may be corrected to correspond to the first-type light emitting element EE1 of the first pixel PXR1. The second intermediate correction data MDS2 may be corrected to correspond to the second-type light emitting element EE2 of the first pixel PXR1.

The third intermediate correction data MDS3 and the fourth intermediate correction data MDS4 may correspond to the second pixel PXR2 in the second area DA-2. For example, the third intermediate correction data MDS3 may be corrected to correspond to the third-type light emitting element EE3 of the second pixel PXR2. The fourth intermediate correction data MDS4 may be corrected to correspond to the fourth-type light emitting element EE4 of the second pixel PXR2.

In an embodiment of the present disclosure, among the intermediate correction data MDS1, MDS2, MDS3, and MDS4 generated by the first correction circuit DCR1, the first intermediate correction data MDS1 and the third intermediate correction data MDS3 may be delivered to the second correction circuit DCR2.

The second correction circuit DCR2 may receive the first intermediate correction data MDS1 and the third intermediate correction data MDS3 from the first correction circuit DCR1. The second correction circuit DCR2 may be configured to generate first-type intermediate correction data MDS1′ by correcting the first intermediate correction data MDS1. The second correction circuit DCR2 may be configured to generate third-type intermediate correction data MDS3′ by correcting the third intermediate correction data MDS3.

In an embodiment of the present disclosure, among the intermediate correction data MDS1, MDS2, MDS3, and MDS4 generated by the first correction circuit DCR1, the second intermediate correction data MDS2 and the fourth intermediate correction data MDS4 may be delivered to the third correction circuit DCR3.

The third correction circuit DCR3 may receive the second intermediate correction data MDS2 and the fourth intermediate correction data MDS4 from the first correction circuit DCR1. The third correction circuit DCR3 may be configured to generate second-type intermediate correction data MDS2′ by correcting the second intermediate correction data MDS2. The third correction circuit DCR3 may be configured to generate fourth-type intermediate correction data MDS4′ by correcting the fourth intermediate correction data MDS4.

The second correction circuit DCR2 and the third correction circuit DCR3 may be utilized when different correction values are required. For example, the second correction circuit DCR2 may be configured to generate data by applying a correction value corresponding to each of the first-type light emitting element EE1 of the first pixel PXR1 and the third-type light emitting element EE3 of the second pixel PXR2. In this case, the first pixel PXR1 and the second pixel PXR2 emit light in the first mode (i.e., the public mode). The third correction circuit DCR3 may be configured to generate data by applying a correction value corresponding to each of the second-type light emitting element EE2 of the first pixel PXR1 and the fourth-type light emitting element EE4 of the second pixel PXR2. In this case, the first pixel PXR1 and the second pixel PXR2 emit light in the second mode (i.e., the private mode).

In an embodiment of the present disclosure, differences in area size and luminous efficiency between the emission areas EEA1, EEA2, EEA3, and EEA4 of the light emitting elements EE1, EE2, EE3, and EE4 located in the first area DA-1 and the second area DA-2 may necessitate distinct correction values for each of the light emitting elements EE1, EE2, EE3, and EE4. For example, when the light emitting elements EE1, EE2, EE3, and EE4 are driven in the first mode or the second mode, different gamma values may be applied, necessitating the application of separate gamma lookup tables corresponding to each gamma value. To accommodate this, the second correction circuit DCR2 and the third correction circuit DCR3 may be connected in parallel and configured to correct the respective intermediate correction data MDS1, MDS2, MDS3, and MDS4. Specifically, the second correction circuit DCR2 and the third correction circuit DCR3 may correct the intermediate correction data MDS1, MDS2, MDS3, and MDS4 associated with the light emitting elements EE1, EE2, EE3, and EE4, ensuring accurate compensation for differences in their emission characteristics.

In an embodiment of the present disclosure, the first intermediate correction data MDS1 and the second intermediate correction data MDS2 may be identical to each other. Additionally, the third intermediate correction data MDS3 and the fourth intermediate correction data MDS4 may be identical to each other. For example, when both the first pixel PXR1 and the second pixel PXR2 operate in the first mode, causing the first-type light emitting element EE1 and the third-type light emitting element EE3 to emit light, the second correction circuit DCR2 may receive the first intermediate correction data MDS1 and may output the first-type intermediate correction data MDS1′. Subsequently, the second correction circuit DCR2 may receive the third intermediate correction data MDS3 and output the third-type intermediate correction data MDS3′. In this case, the third correction circuit DCR3 may remain unused circuit and can be turned off. Accordingly, depending on the operating mode of the display panel DP, the unnecessary correction circuit, either the second correction circuit DCR2 or the third correction circuit DCR3, may be deactivated. This selective deactivation reduces the power consumption of the electronic device ED (see FIG. 1A).

In an embodiment of the present disclosure, the fourth correction circuit DCR4 may receive at least one of the first-type intermediate correction data MDS1′ and the third-type intermediate correction data MDS3′, which are generated by the second correction circuit DCR2. Alternatively, the fourth correction circuit DCR4 may receive at least one of the second-type intermediate correction data MDS2′ and the fourth-type intermediate correction data MDS4′, which are generated by the third correction circuit DCR3.

When receiving at least one of the first-type intermediate correction data MDS1′ and the second-type intermediate correction data MDS2′, the fourth correction circuit DCR4 may perform a secondary correction on the received data to generate first correction data DATA1. When receiving at least one of the third-type intermediate correction data MDS3′ and the fourth-type intermediate correction data MDS4′, the fourth correction circuit DCR4 may perform a secondary correction on the received data to generate second correction data DATA2. The first correction data DATA1 may be converted by the data driving circuit DDI (see FIG. 3) and then delivered to the first pixel PXR1. The second correction data DATA2 may be converted by the data driving circuit DDI (see FIG. 3) and then delivered to the second pixel PXR2.

Like the first correction circuit DCR1, the fourth correction circuit DCR4 may be configured to perform corrections regardless of whether the first area DA-1 and the second area DA-2 operate in the first mode or the second mode. For example, regardless of the mode, the fourth correction circuit DCR4 may carry out image quality corrections corresponding to the luminance values of the first pixel PXR1 located in the first area DA-1 and the second pixel PXR2 located in the second area DA-2. The first correction data DATA1 and the second correction data DATA2, which are generated by the fourth correction circuit DCR4, may be referred to as “correction data DATA.”

In an embodiment of the present disclosure, the correction data DATA generated by the fourth correction circuit DCR4 may be delivered to the data driving circuit DDI (see FIG. 3). The data driving circuit DDI (see FIG. 3) may provide the correction data DATA to the corresponding light emitting elements EE1, EE2, EE3, and EE4. The correction data DATA described in FIG. 6 may be the same as the image data signal DATA of FIG. 3. Hereinafter, the image data signal DATA of FIG. 3 is referred to as the “correction data DATA”.

In an embodiment of the present disclosure, the driving controller TC may further include a phase locked loop (PLL). The phase locked loop PLL may include a first phase locked loop PLL1 and a second phase locked loop PLL2. The first phase locked loop PLL1 may output a first clock signal CLK1, and the second phase locked loop PLL2 may output a second clock signal CLK2. The first clock signal CLK1 output from the first phase locked loop PLL1 may be delivered to the second correction circuit DCR2, and the second clock signal CLK2 output from the second phase locked loop PLL2 may be delivered to the third correction circuit DCR3. Accordingly, the second correction circuit DCR2 and the third correction circuit DCR3 may be turned on or off in response to their respective clock signals CLK1 and CLK2.

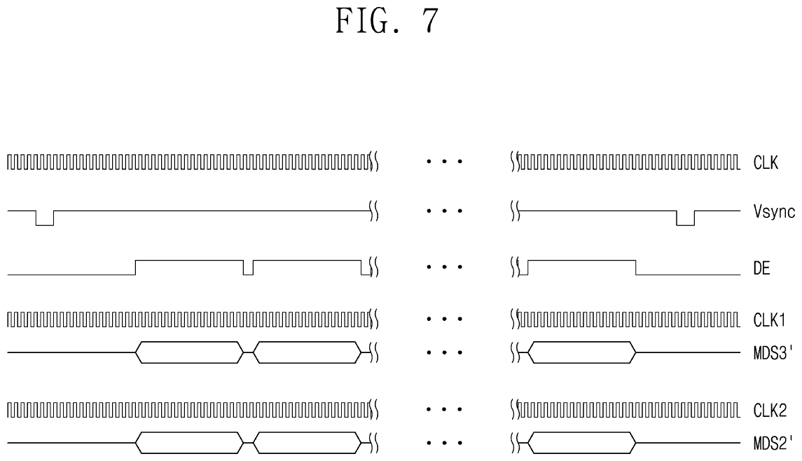

FIG. 7 is a timing diagram showing signals, according to an embodiment of the present disclosure.

In FIG. 7, a main clock signal CLK, a vertical synchronization signal Vsync, a data enable signal DE, the first clock signal CLK1, and the second clock signal CLK2 are shown.

Referring to FIGS. 3, 5, 6, and 7, the main clock signal CLK, the vertical synchronization signal Vsync, and the data enable signal DE may be included in the control signal CTRL output from the central processing device AP.

The main clock signal CLK may be a timing signal for determining the output timing of all signals for driving the display panel DP. The vertical synchronization signal Vsync may be a signal indicating the start of one frame of an image displayed on the display panel DP. The data enable signal DE may be a signal set to a certain level (e.g., a high level) corresponding to the section where image data is being input.

The first clock signal CLK1 may be output from the first phase locked loop PLL1 and delivered to the second correction circuit DCR2. Accordingly, when the first pixel PXR1 and the second pixel PXR2 are driven in the first mode, the first clock signal CLK1 may be provided to the second correction circuit DCR2.

The second clock signal CLK2 may be output from the second phase locked loop PLL2 and delivered to the third correction circuit DCR3. Accordingly, when the first pixel PXR1 and the second pixel PXR2 are driven in the second mode, the second clock signal CLK2 may be provided to the third correction circuit DCR3.

In an embodiment of the present disclosure, the signals in FIG. 7 may be illustrated in a timing diagram showing that the first pixel PXR1 located in the first area DA-1 is driven in the second mode, and the second pixel PXR2 located in the second area DA-2 is driven in the first mode. Hereinafter, a case where the first pixel PXR1 in the first area DA-1 is driven in the second mode, and the second pixel PXR2 in the second area DA-2 is driven in the first mode may be referred to as a “division mode”.

In an embodiment of the present disclosure, in the division mode, both the second correction circuit DCR2 and the third correction circuit DCR3 may be turned on. Accordingly, the first phase locked loop PLL1 may generate the first clock signal CLK1 and may output the first clock signal CLK1 to the second correction circuit DCR2. The second phase locked loop PLL2 may generate the second clock signal CLK2 and may output the second clock signal CLK2 to the third correction circuit DCR3.

When the second pixel PXR2 in the second area DA-2 is driven in the first mode, the second correction circuit DCR2 may receive the first clock signal CLK1. The second correction circuit DCR2 may correct the third intermediate correction data MDS3, which corresponds to the third-type light emitting element EE3 of the second pixel PXR2, to generate the third-type intermediate correction data MDS3′. The third-type intermediate correction data MDS3′ may be output in synchronization with the data enable signal DE.

When the first pixel PXR1 in the first area DA-1 is driven in the second mode, the third correction circuit DCR3 may receive the second clock signal CLK2. The third correction circuit DCR3 may correct the second intermediate correction data MDS2, which corresponds to the second-type light emitting element EE2 of the first pixel PXR1, to generate the second-type intermediate correction data MDS2′. The second-type intermediate correction data MDS2′ may be output in synchronization with the data enable signal DE.

The third-type intermediate correction data MDS3′ generated by the second correction circuit DCR2 and the second-type intermediate correction data MDS2′ generated by the third correction circuit DCR3 may be delivered to the fourth correction circuit DCR4. The fourth correction circuit DCR4 may correct the third-type intermediate correction data MDS3′ and the second-type intermediate correction data MDS2′ to generate the correction data DATA. Accordingly, the correction data DATA generated by the fourth correction circuit DCR4 may be output to the data driving circuit DDI.

The correction data DATA may include the first correction data DATA1 and the second correction data DATA2. The first correction data DATA1 corresponds to the first pixel PXR1. The second correction data DATA2 corresponds to the second pixel PXR2. In an embodiment of the present disclosure, in the division mode, the first correction data DATA1 may be obtained by correcting the second-type intermediate correction data MDS2′, and the second correction data DATA2 may be obtained by correcting the third-type intermediate correction data MDS3′.

In an embodiment of the present disclosure, the first correction data DATA1 generated by the fourth correction circuit DCR4 may be provided to the second-type light emitting element EE2 of the first pixel PXR1, and the second correction data DATA2 generated by the fourth correction circuit DCR4 may be provided to the third-type light emitting element EE3 of the second pixel PXR2.

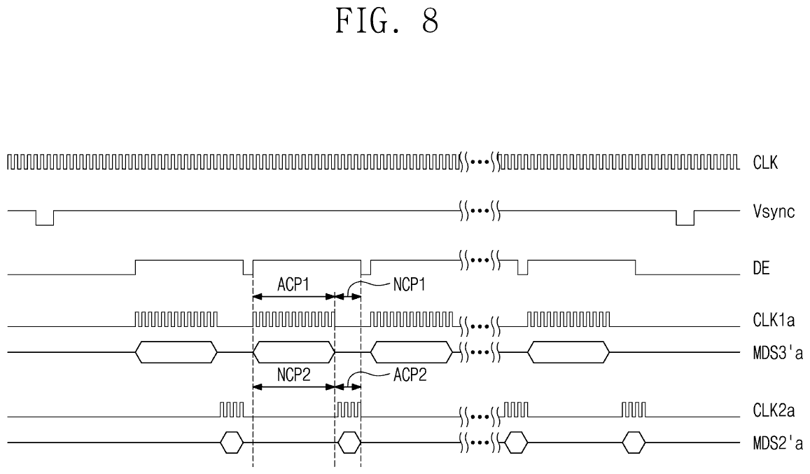

FIG. 8 is a timing diagram showing signals, according to an embodiment of the present disclosure. In the description of FIG. 8, the same reference numerals are used for configurations identical to those in FIG. 7, and thus the descriptions thereof are omitted.

Referring to FIGS. 3, 5, 6, 7, and 8, like that illustrated in FIG. 7, FIG. 8 illustrates a timing diagram showing that the first pixel PXR1 in the first area DA-1 is driven in a second mode, and the second pixel PXR2 in the second area DA-2 is driven in a first mode.

Both the second correction circuit DCR2 and the third correction circuit DCR3 may be turned on. In this case, the first phase locked loop PLL1 may generate a first clock signal CLK1a and may output the first clock signal CLK1a to the second correction circuit DCR2. The second phase locked loop PLL2 may generate a second clock signal CLK2a and may output the second clock signal CLK2a to the third correction circuit DCR3.

When the second pixel PXR2 in the second area DA-2 is driven in the first mode, the second correction circuit DCR2 may receive the first clock signal CLK1a. The second correction circuit DCR2 may correct the third intermediate correction data MDS3, which corresponds to the third-type light emitting element EE3 of the second pixel PXR2, to generate the third-type intermediate correction data MDS3′a.

When the first pixel PXR1 in the first area DA-1 is driven in the second mode, the third correction circuit DCR3 may receive the second clock signal CLK2a. The third correction circuit DCR3 may correct the second intermediate correction data MDS2, which corresponds to the second-type light emitting element EE2 of the first pixel PXR1, to generate the second-type intermediate correction data MDS2′a.

The third-type intermediate correction data MDS3′a generated by the second correction circuit DCR2 and the second-type intermediate correction data MDS2′a generated by the third correction circuit DCR3 may be delivered to the fourth correction circuit DCR4. The fourth correction circuit DCR4 may correct the third-type intermediate correction data MDS3′a and the second-type intermediate correction data MDS2′a to generate the correction data DATA. Accordingly, the correction data DATA generated by the fourth correction circuit DCR4 may be output to the data driving circuit DDI.

In FIG. 7, both the first clock signal CLK1 and the second clock signal CLK2 have continuous waveforms, and their active periods overlap each other. However, in an embodiment of the present disclosure, as shown in FIG. 8, an active period ACP1 of the first clock signal CLK1a may not overlap an active period ACP2 of the second clock signal CLK2a in time. Accordingly, the active period ACP1 of the first clock signal CLK1a may overlap an inactive period NCP2 of the second clock signal CLK2a. The active period ACP2 of the second clock signal CLK2a may overlap an inactive period NCP1 of the first clock signal CLK1a.

In an embodiment of the present disclosure, in a division mode where the first pixel PXR1 in the first area DA-1 operates in the second mode and the second pixel PXR2 in the second area DA-2 operates in the first mode, the data for the second pixel PXR2 may be processed through a correction operation performed by the second correction circuit DCR2. Similarly, the data for the first pixel PXR1 in the first area DA-1 may be processed through a correction operation performed by the third correction circuit DCR3.

In an embodiment of the present disclosure, intermediate correction data generated by the second correction circuit DCR2 and intermediate correction data generated by the third correction circuit DCR3 may be output alternately. Accordingly, when the second correction circuit DCR2 operates, the third correction circuit DCR3 may be turned off. Moreover, when the third correction circuit DCR3 operates, the second correction circuit DCR2 may be turned off. Accordingly, one of the second correction circuit DCR2 and the third correction circuit DCR3 may be periodically turned off, and thus the power consumption of the electronic device ED (see FIG. 1A) may be reduced.

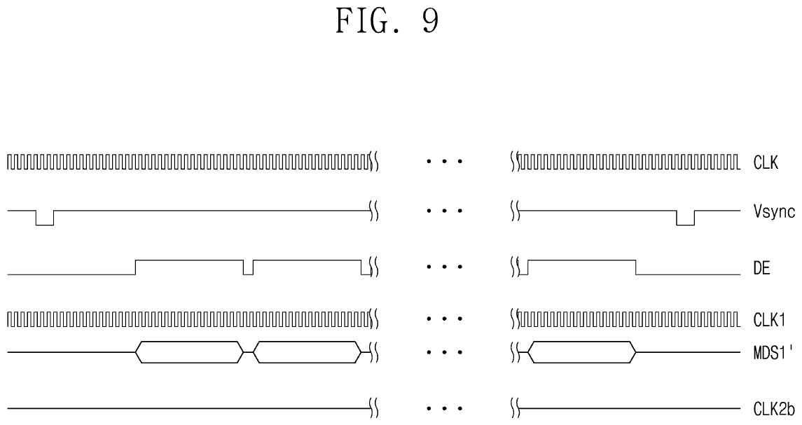

FIG. 9 is a timing diagram showing signals, according to an embodiment of the present disclosure. In the description of FIG. 9, the same reference numerals are used for configurations identical to those in FIG. 7, and thus the descriptions thereof are omitted.

Referring to FIGS. 3, 5, 6, and 9, both the first pixel PXR1 in the first area DA-1 and the second pixel PXR2 in the second area DA-2 may be driven in a first mode.

In an embodiment of the present disclosure, when both the first pixel PXR1 in the first area DA-1 and the second pixel PXR2 in the second area DA-2 are driven in the first mode, the operating mode of the display panel DP may be referred to as an “entire public mode”. FIG. 9 shows only signals for the first pixel PXR1 in the first area DA-1. However, the second pixel PXR2 operates in the same manner as the first pixel PXR1. Therefore, the description of the second pixel PXR2 in the second area DA-2 is provided briefly.

Referring to FIGS. 5, 6, and 9, in the entire public mode, the second correction circuit DCR2 may be turned on, and the third correction circuit DCR3 may be turned off. Accordingly, the first phase locked loop PLL1 may generate the first clock signal CLK1 and may output the first clock signal CLK1 to the second correction circuit DCR2. However, because the third correction circuit DCR3 is turned off, the second clock signal CLK2b of the second phase locked loop PLL2 may be deactivated.

When the first pixel PXR1 in the first area DA-1 is driven in the first mode, the second correction circuit DCR2 may receive the first clock signal CLK1. The second correction circuit DCR2 may correct the first intermediate correction data MDS1, which corresponds to the first-type light emitting element EE1 of the first pixel PXR1, to generate the first-type intermediate correction data MDS1′.

The third correction circuit DCR3 may be turned off, causing the second clock signal CLK2b to remain at an inactive level or to not be output from the second phase locked loop PLL2 at all. As a result of the third correction circuit DCR3 being turned off, the second intermediate correction data MDS2 may not undergo correction. Consequently, the second-type intermediate correction data MDS2′ may not be generated.

When the second pixel PXR2 in the second area DA-2 is driven in the first mode, the second correction circuit DCR2 may receive the first clock signal CLK1. The second correction circuit DCR2 may correct the third intermediate correction data MDS3, which corresponds to the third-type light emitting element EE3 of the second pixel PXR2, to generate the third-type intermediate correction data MDS3′.

The first-type intermediate correction data MDS1′ and the third-type intermediate correction data MDS3′ generated by the second correction circuit DCR2 may be delivered to the fourth correction circuit DCR4. The fourth correction circuit DCR4 may correct the first-type intermediate correction data MDS1′ to generate the first correction data DATA1. The fourth correction circuit DCR4 may correct the third-type intermediate correction data MDS3′ to generate the second correction data DATA2.

In an embodiment of the present disclosure, the first correction data DATA1 corresponding to the first-type intermediate correction data MDS1′ may be provided to the first-type light emitting element EE1 of the first pixel PXR1. The second correction data DATA2 corresponding to the third-type intermediate correction data MDS3′ may be provided to the third-type light emitting element EE3 of the second pixel PXR2.

In an embodiment of the present disclosure, when the display panel DP is driven in the entire public mode, only the first-type light emitting element EE1 of the first pixel PXR1 and the third-type light emitting element EE3 of the second pixel PXR2 may emit light, and the second-type light emitting element EE2 of the first pixel PXR1 and the fourth-type light emitting element EE4 of the second pixel PXR2 may not emit light. Accordingly, the third correction circuit DCR3, which performs correction corresponding to the second-type light-emitting element EE2 of the first pixel PXR1 and the fourth-type light-emitting element EE4 of the second pixel PXR2, may remain unused. In other words, during the entire public mode, the second correction circuit DCR2 may be turned on, while the third correction circuit DCR3 may be turned off. As a result, only the necessary correction units DCR1, DCR2, DCR3, and DCR4 required for driving the display panel DP are selectively activated. By turning off the unnecessary correction circuit, either the second correction circuit DCR2 or the third correction circuit DCR3, depending on the operating mode of the display panel DP, the power consumption of the electronic device ED (see FIG. 1A) can be reduced.

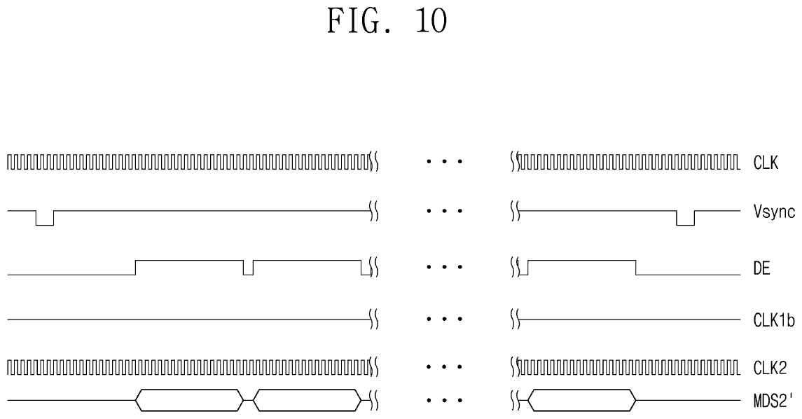

FIG. 10 is a timing diagram showing signals, according to an embodiment of the present disclosure. In the description of FIG. 10, the same reference numerals are used for configurations identical to those in FIG. 7, and thus the descriptions thereof are omitted.

Referring to FIGS. 3, 5, 6, and 10, in FIGS. 7, 8, and 9, it has been described that a single driving controller TC corrects all data provided to the first area DA-1 and the second area DA-2. However, in FIG. 10, it is described that the single driving controller TC corrects data provided to only one display area, for example, the first area DA-1a (see FIG. 1B). FIG. 10 may illustrate a timing diagram showing the operation of the first pixel PXR1 in the first area DA-1a when driven in a second mode.

A pixel in the first area DA-1a of the first display panel DPa illustrated in FIG. 1B may be substantially identical to the first pixel PXR1 illustrated in FIG. 5. Accordingly, in an embodiment, the pixel in the first area DA-1a of the first display panel DPa is described as the first pixel PXR1.

When the first pixel PXR1, located in the first area DA-1a, is driven in the second mode, the entire first display panel DPa operates in the second mode. This may be referred to as an “entire private mode”.

In the entire private mode, the second correction circuit DCR2 may be turned off, and the third correction circuit DCR3 may be turned on. Accordingly, the second phase locked loop PLL2 may output the second clock signal CLK2 to the third correction circuit DCR3. However, because the second correction circuit DCR2 is turned off, the first clock signal CLK1b of the first phase locked loop PLL1 may be deactivated.

When the first pixel PXR1 is driven in the second mode, the third correction circuit DCR3 may receive the second clock signal CLK2. The third correction circuit DCR3 may correct the second intermediate correction data MDS2, which corresponds to the second-type light emitting element EE2 of the first pixel PXR1, to generate the second-type intermediate correction data MDS2′.

The second correction circuit DCR2 may be turned off, causing the first clock signal CLK1b to remain at an inactive level or may not be output from the first phase locked loop PLL1 at all. As a result of the second correction circuit DCR2 being turned off, the first intermediate correction data MDS1 may not undergo correction. Consequently, the first-type intermediate correction data MDS1′ may not be generated.

The second-type intermediate correction data MDS2′ generated by the third correction circuit DCR3 may be delivered to the fourth correction circuit DCR4. The fourth correction circuit DCR4 may correct the second-type intermediate correction data MDS2′ to generate the first correction data DATA1. Moreover, the first correction data DATA1, which corresponds to the second-type intermediate correction data MDS2′, may be provided to the second-type light emitting element EE2 of the first pixel PXR1.

In an embodiment of the present disclosure, when the first display panel DPa is driven in the entire private mode, only the second-type light emitting element EE2 of the first pixel PXR1 may emit light, and the first-type light emitting element EE1 of the first pixel PXR1 may not emit light. Consequently, the second correction circuit DCR2, which performs corrections for the first-type light-emitting element EE1, may remain unused. In other words, in the entire private mode, the third correction circuit DCR3 may be turned on, and the second correction circuit DCR2 may be turned off. This selective activation ensures that only the correction circuits necessary for driving the display panel DPa are turned on. As a result, the unused correction circuit, either the second correction circuit DCR2 or the third correction circuit DCR3, may be turned off depending on the operating mode of the display panel DPa, thereby reducing the power consumption of the electronic device EDa (see FIG. 1B).

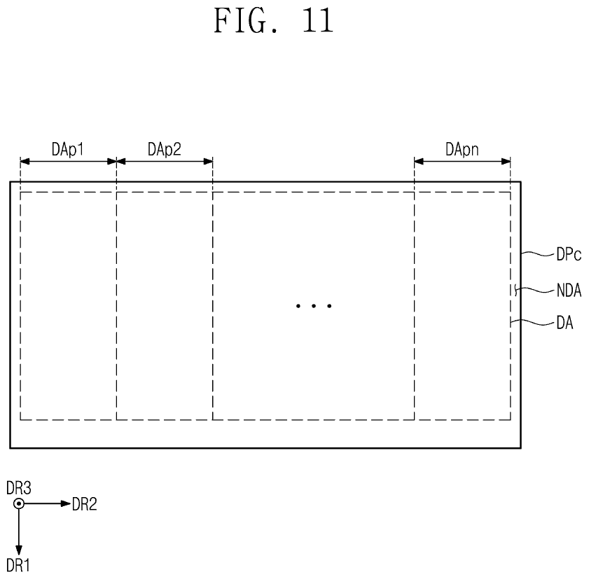

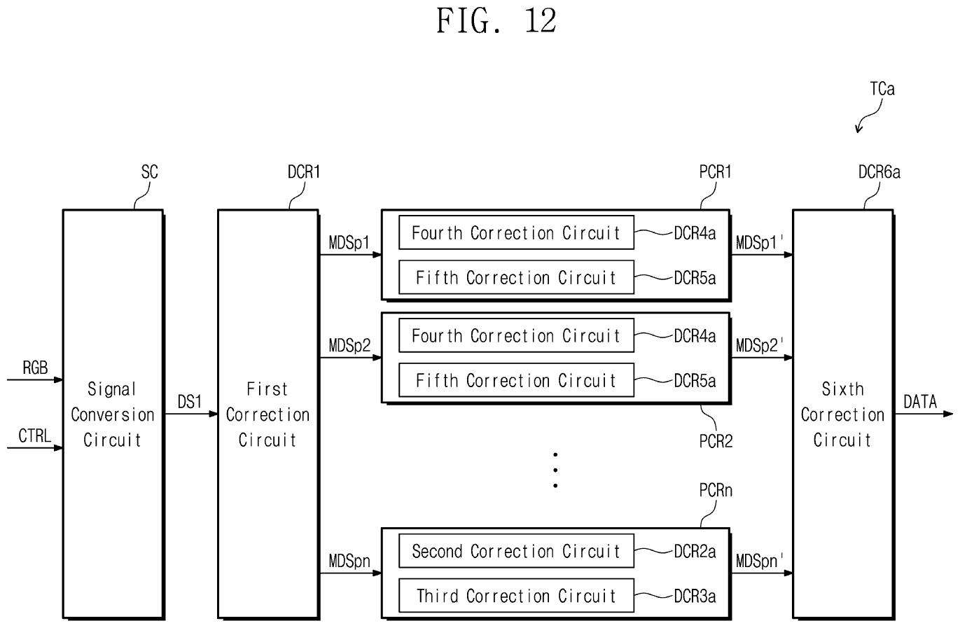

FIG. 11 is a drawing illustrating a plan view of a display panel DPc, according to an embodiment of the present disclosure. FIG. 12 is a block diagram showing a configuration for data correction of a driving controller TCa, according to an embodiment of the present disclosure. In the description of FIG. 12, the same reference numerals are used for configurations identical to those in FIG. 6, and thus the descriptions thereof are omitted.

The driving controller TCa of FIG. 12 may further include the signal conversion circuit SC, the first correction circuit DCR1, a first division correction circuit PCR1, second to n-th division correction circuits PCR2 to PCRn, and a sixth correction circuit DCR6a. In an embodiment of the present disclosure, at least some blocks may be omitted. In other words, some of the blocks shown in FIG. 12 may be combined.

Referring to FIGS. 6, 11, and 12, the display panel DPc may include ‘n’ division areas DAp1 and DAp2 to DApn, and the driving controller TCa may include ‘n’ division correction units PCR1 and PCR2 to PCRn. The ‘n’ division areas DAp1 and DAp2 to DApn and the ‘n’ division correction units PCR1 and PCR2 to PCRn may have a one-to-one correspondence. For example, the first division area DAp1 and the first division correction circuit PCR1 may have a one-to-one correspondence; the second division area DAp2 and the second division correction circuit PCR2 may have a one-to-one correspondence; and, the n-th division area DApn and the n-th division correction circuit PCRn may have a one-to-one correspondence. For example, the first division correction circuit PCR1 may correct data provided by the first division area DAp1. The n-th division correction circuit PCRn may correct data provided by the n-th division area DApn.

In an embodiment of the present disclosure, referring to FIG. 5 together, the second area DA-2 may include the first division area DAp1 and the second division area DAp2, and the first area DA-1 may include the n-th division area DApn. Accordingly, each of pixels respectively located in the first division area DAp1 and the second division area DAp2 may be referred to as the “second pixel PXR2”. A pixel located in the n-th division area DApn may be referred to as the “first pixel PXR1”.

The first correction circuit DCR1 may generate first division data MDSp1 and second to n-th division data MDSp2 to MDSpn. The ‘n’ division data MDSp1 and MDSp2 to MDSpn may be output in one-to-one correspondence to the ‘n’ division correction units PCR1 and PCR2 to PCRn, respectively. For example, the first division data MDSp1 may be output to the first division correction circuit PCR1; the second division data MDSp2 may be output to the second division correction circuit PCR2; and, the n-th division data MDSpn may be output as the n-th division correction circuit PCRn.

In an embodiment of the present disclosure, the first division data MDSp1 and the second division data MDSp2 may correspond to the third intermediate correction data MDS3 and the fourth intermediate correction data MDS4 illustrated in FIG. 6, respectively. Moreover, the n-th division data MDSpn may correspond to the first intermediate correction data MDS1 and the second intermediate correction data MDS2.

In an embodiment of the present disclosure, the first division correction circuit PCR1 may receive the first division data MDSp1 and may include a fourth correction circuit DCR4a and a fifth correction circuit DCR5a. The fourth correction circuit DCR4a and the fifth correction circuit DCR5a illustrated in FIG. 12 may perform operations of the second correction circuit DCR2 and the third correction circuit DCR3 described with reference to FIG. 6, respectively. The fourth correction circuit DCR4a may be referred to as the “second correction circuit DCR2”, and the fifth correction circuit DCR5a may be referred to as the “third correction circuit DCR3”. The second division correction circuit PCR2 may receive the second division data MDSp2 and may also include a fourth correction circuit DCR4a and a fifth correction circuit DCR5a.

The n-th division correction circuit PCRn may receive the n-th division data MDSpn and may include a second correction circuit DCR2a and a third correction circuit DCR3a. The second correction circuit DCR2a and the third correction circuit DCR3a illustrated in FIG. 12 may perform operations of the second correction circuit DCR2 and the third correction circuit DCR3 described with reference to FIG. 6, respectively.

In an embodiment of the present disclosure, the first to n-th division correction circuits PCR1 and PCR2 to PCRn may respectively correct the first to n-th division data MDSp1 and MDSp2 to MDSpn, may generate corresponding first to n-th intermediate division data MDSp1′ and MDSp2′ to MDSpn′, and may output the first to n-th intermediate division data MDSp1′ and MDSp2′ to MDSpn′ to the sixth correction circuit DCR6a.

The first intermediate division data MDSp1′ and the second intermediate division data MDSp2′ may correspond to the first division area DAp1 and the second division area DAp2. The first intermediate division data MDSp1′ and the second intermediate division data MDSp2′ may correspond to the second pixel PXR2. Furthermore, the n-th intermediate division data MDSpn′ may correspond to the n-th division area DApn. The n-th intermediate division data MDSpn′ may correspond to the first pixel PXR1.

The sixth correction circuit DCR6a may generate the correction data DATA by correcting the first to n-th intermediate division data MDSp1′ and MDSp2′ to MDSpn′ received from the first to n-th division correction circuits PCR1 and PCR2 to PCRn. In an embodiment of the present disclosure, the sixth correction circuit DCR6a may perform the operation of the fourth correction circuit DCR4 described with reference to FIG. 6, and the sixth correction circuit DCR6a may also be referred to as the “fourth correction circuit DCR4”.

In an embodiment of the present disclosure, the ‘n’ division correction units PCR1 and PCR2 to PCRn may be provided for the ‘n’ division areas DAp1 and DAp2 to DApn, where each correction unit corresponds to specific area. In this case, the correction values applied to data for each of the ‘n’ division areas DAp1 and DAp2 to DApn may be set differently. For example, the first division area DAp1 may be closer to a window than the second division area DAp2, and thus more affected by external factors such as sunlight. Accordingly, a correction value applied to data for the first division area DAp1 may be different from a correction value applied to data for the second division area DAp2. Accordingly, the display quality of the electronic device ED (see FIG. 1A) may be further improved.

In an embodiment of the present disclosure, only the correction operation of the first correction circuit DCR1 and the correction operation of the sixth correction circuit DCR6a may be performed on the image displayed in some of the ‘n’ division areas DAp1 and DAp2 to DApn. In this case, some of the ‘n’ division correction units PCR1 and PCR2 to PCRn corresponding to some division areas may be turned off. For example, when the n-th division correction circuit PCRn is turned off, the n-th division correction circuit PCRn may not perform a correction operation on the n-th division area DApn. In this case, only the other division correction units, excluding the n-th division correction circuit PCRn, may perform correction operations on their corresponding division areas. Accordingly, some of the ‘n’ division correction units PCR1 and PCR2 to PCRn may be turned off as needed. By turning of these unused division correction units, the power consumption of the electronic device ED (see FIG. 1A) may be reduced proportionally to the number of inactive division correction units.

Moreover, in an embodiment of the present disclosure, when there is no need to display images for the passenger seat, the correction units that output data to the first area DA-1 (see FIG. 1A) among the ‘n’ division correction units PCR1 and PCR2 to PCRn may be turned off. Depending on the operating mode of the display panel DP (see FIG. 1A), any unnecessary division correction units PCR1 and PCR2 to PCRn may be turned off. As a result, the power consumption of the electronic device ED (see FIG. 1A) may be reduced.

Although an embodiment of the present disclosure has been described for illustrative purposes, those skilled in the art will appreciate that various modifications, and substitutions are possible, without departing from the scope and spirit of the present disclosure as set forth in the accompanying claims. Accordingly, the technical scope of the present disclosure is not limited to the detailed description of this specification.

As described above, an electronic device may include a pixel, which includes a first-type light emitting element and a second-type light emitting element, a first correction circuit, a second correction circuit, a third correction circuit, and a fourth correction circuit. The first-type light emitting element and the second-type light emitting element may selectively emit light or remain inactive, depending on the operating mode of the display panel. The second correction circuit may correct data corresponding to the first-type light emitting element, and the third correction circuit may correct data corresponding to the second-type light emitting element.

Depending on the operating mode of the display panel, either the second correction circuit or the third correction circuit may correspond to an unused circuit configuration and can be turned off. By selectively turning off the unnecessary correction circuit based on the display panel's operating mode, the power consumption of the electronic device can be reduced.

Although the present disclosure has been described with reference to specific embodiments, those skilled in the art will recognize that various changes and modifications can be made without departing from the spirit and scope of the disclosure, as set forth in the following claims.

What is claimed is:

1. An electronic device comprising:
a display panel including a first pixel including a first pixel circuit, a first-type light emitting element electrically connected to the first pixel circuit, and a second-type light emitting element electrically connected to the first pixel circuit, wherein the first pixel is configured to operate in a first mode or a second mode different from the first mode;
a first correction circuit configured to receive data and generate intermediate correction data by performing a primary correction on the data;
a second correction circuit configured to generate first-type intermediate correction data by correcting first intermediate correction data corresponding to the first-type light emitting element among the intermediate correction data; and
a third correction circuit configured to generate second-type intermediate correction data by correcting second intermediate correction data corresponding to the second-type light emitting element among the intermediate correction data.

2. The electronic device of claim 1, wherein when the first pixel operates in the first mode, the first-type light emitting element emits light, and the second-type light emitting element does not emit light, and
wherein when the first pixel operates in the second mode, the first-type light emitting element does not emit light, and the second-type light emitting element emits light.

3. The electronic device of claim 2, wherein when the first pixel operates in the first mode, the second correction circuit is turned on, and the third correction circuit is turned off, and
wherein when the first pixel operates in the second mode, the second correction circuit is turned off, and the third correction circuit is turned on.

4. The electronic device of claim 1, wherein a first area, in which the first pixel is placed, and a second area adjacent to the first area are defined in the display panel, and
wherein the display panel further includes a second pixel placed in the second area, the second pixel including a second pixel circuit, a third-type light emitting element electrically connected to the second pixel circuit, and a fourth-type light emitting element electrically connected to the second pixel circuit.

5. The electronic device of claim 4, wherein the second correction circuit is configured to generate third-type intermediate correction data by correcting third intermediate correction data corresponding to the third-type light emitting element among the intermediate correction data, and
wherein the third correction circuit is configured to generate fourth-type intermediate correction data by correcting fourth intermediate correction data corresponding to the fourth-type light emitting element among the intermediate correction data.

6. The electronic device of claim 5, wherein when the first pixel operates in the second mode and the second pixel operates in the first mode, the first-type light emitting element does not emit light, the second-type light emitting element emits light, the third-type light emitting element emits light, the fourth-type light emitting element does not emit light, the second correction circuit and the third correction circuit are turned on, the second correction circuit is configured to generate the third-type intermediate correction data, and the third correction circuit is configured to generate the second-type intermediate correction data.

7. The electronic device of claim 5, wherein when the first pixel and the second pixel operate in the first mode, the first-type light emitting element emits light, the second-type light emitting element does not emit light, the third-type light emitting element emits light, the fourth-type light emitting element does not emit light, the second correction circuit is turned on, the third correction circuit is turned off, and the second correction circuit is configured to generate the first-type intermediate correction data and the third-type intermediate correction data.

8. The electronic device of claim 5, wherein when the first pixel and the second pixel operate in the second mode, the first-type light emitting element does not emit light, the second-type light emitting element emits light, the third-type light emitting element does not emit light, the fourth-type light emitting element emits light, the second correction circuit is turned off, the third correction circuit is turned on, and the third correction circuit is configured to generate the second-type intermediate correction data and the fourth-type intermediate correction data.

9. The electronic device of claim 5, further comprising:
a fourth correction circuit configured to receive at least one of the first-type intermediate correction data, the second-type intermediate correction data, the third-type intermediate correction data, and the fourth-type intermediate correction data,
wherein the fourth correction circuit is configured to generate first correction data by performing a secondary correction on at least one of the first-type intermediate correction data and the second-type intermediate correction data, and the fourth correction circuit is configured to generate second correction data by performing a secondary correction on at least one of the third-type intermediate correction data and the fourth-type intermediate correction data.

10. The electronic device of claim 9, wherein when the first pixel operates in the second mode and the second pixel operates in the first mode, the first correction data is provided to the second-type light emitting element, and the second correction data is provided to the third-type light emitting element.

11. The electronic device of claim 9, wherein when the first pixel and the second pixel operate in the first mode, the first correction data is provided to the first-type light emitting element, and the second correction data is provided to the third-type light emitting element.

12. The electronic device of claim 9, wherein when the first pixel and the second pixel operate in the second mode, the first correction data is provided to the second-type light emitting element, and the second correction data is provided to the fourth-type light emitting element.

13. The electronic device of claim 5, further comprising:
a phase locked loop configured to output a first clock signal and a second clock signal,
wherein when the second correction circuit is turned on, the phase locked loop is configured to output the first clock signal to the second correction circuit, and
wherein when the third correction circuit is turned on, the phase locked loop is configured to output the second clock signal to the third correction circuit.

14. The electronic device of claim 13, wherein an active period of the first clock signal overlaps an inactive period of the second clock signal, and an active period of the second clock signal overlaps an inactive period of the first clock signal.

15. The electronic device of claim 4, further comprising:
a fourth correction circuit configured to generate third-type intermediate correction data by correcting third intermediate correction data corresponding to the third-type light emitting element among the intermediate correction data; and
a fifth correction circuit configured to generate fourth-type intermediate correction data by correcting fourth intermediate correction data corresponding to the fourth-type light emitting element among the intermediate correction data.

16. An electronic device comprising:
a display panel including a first pixel and a second pixel, wherein the first pixel includes a first pixel circuit, a first-type light emitting element electrically connected to the first pixel circuit, and a second-type light emitting element electrically connected to the first pixel circuit, and the second pixel includes a second pixel circuit, a third-type light emitting element electrically connected to the second pixel circuit, and a fourth-type light emitting element electrically connected to the second pixel circuit;
a first correction circuit configured to receive data and generate intermediate correction data by performing a primary correction on the data;
a second correction circuit configured to generate first-type intermediate correction data by correcting first intermediate correction data corresponding to the first-type light emitting element among the intermediate correction data, and generate third-type intermediate correction data by correcting third intermediate correction data corresponding to the third-type light emitting element among the intermediate correction data; and
a third correction circuit configured to generate second-type intermediate correction data by correcting second intermediate correction data corresponding to the second-type light emitting element among the intermediate correction data, and generate fourth-type intermediate correction data by correcting fourth intermediate correction data corresponding to the fourth-type light emitting element among the intermediate correction data.

17. The electronic device of claim 16, wherein a first area and a second area adjacent to the first area are provided on the display panel, and
wherein the first pixel is placed in the first area, the second pixel is placed in the second area, and the first pixel and the second pixel are configured to be driven in a first mode or in a second mode different from the first mode.

18. The electronic device of claim 17, wherein when the first pixel is driven in the second mode and the second pixel is driven in the first mode, the first-type light emitting element does not emit light, the second-type light emitting element emits light, the third-type light emitting element emits light, the fourth-type light emitting element does not emit light, the second correction circuit and the third correction circuit are turned on, the second correction circuit is configured to generate the third-type intermediate correction data, and the third correction circuit is configured to generate the second-type intermediate correction data.

19. The electronic device of claim 17, wherein when the first pixel and the second pixel are driven in the first mode, the first-type light emitting element emits light, the second-type light emitting element does not emit light, the third-type light emitting element emits light, the fourth-type light emitting element does not emit light, the second correction circuit is turned on, the third correction circuit is turned off, and the second correction circuit is configured to generate the first-type intermediate correction data and the third-type intermediate correction data, and
wherein when the first pixel and the second pixel are driven in the second mode, the first-type light emitting element does not emit light, the second-type light emitting element emits light, the third-type light emitting element does not emit light, the fourth-type light emitting element emits light, the second correction circuit is turned off, the third correction circuit is turned on, and the third correction circuit is configured to generate the second-type intermediate correction data and the fourth-type intermediate correction data.

20. The electronic device of claim 16, further comprising:
a first division correction circuit configured to receive a first portion of the intermediate correction data, the first division correction circuit including the second correction circuit and the third correction circuit; and
a second division correction circuit configured to receive a second portion of the intermediate correction data,
wherein the display panel includes a first division area and a second division area,
wherein the first division correction circuit is configured to correct the first portion of the intermediate correction data that is provided to the first division area, and
wherein the second division correction circuit is configured to correct the second portion of the intermediate correction data that is provided to the second division area.
